(19) United States
(12) Patent Application Publication
(10) Pub. No.: US 2022/0292567 A1
(43) Pub. Date: Sep. 15, 2022

(54) INFERRING CATEGORIES IN A PRODUCT TAXONOMY USING A REPLACEMENT MODEL

(71) Applicant: Maplebear, Inc. (dba Instacart), San Francisco, CA (US)

(72) Inventors: Shishir Kumar Prasad, Fremont, CA (US); Sharath Rao Karikurve, Berkeley, CA (US); Abhay Pawar, Emeryville, CA (US)

(21) Appl. No.: 17/196,855

(22) Filed: Mar. 9, 2021

(51) Int. Cl. G06Q 30/06; G06Q 10/08; G06F 16/28; G06F 16/2457; G06N 20/00

(52) U.S. Cl. CPC G06Q 30/0631; G06Q 10/087; G06F 16/285; G06F 16/24573; G06N 20/00

(57) ABSTRACT

An online concierge system accesses a hierarchical taxonomy of products each labeled with a category of the hierarchical taxonomy. The online concierge system receives, from an inventory database, an unlabeled product, which not included in the hierarchical taxonomy. The online concierge system inputs the unlabeled product to a replacement model. The replacement model is trained to output, for each of one or more labeled products from the hierarchical taxonomy, a likelihood that a user would select the labeled product as a replacement for an input product. The online concierge system selects a labeled product from the one or more labeled products based on the likelihoods. The online concierge system adds the unlabeled product to a category of the hierarchical taxonomy based on the selected labeled product.

### BACKGROUND

This disclosure generally relates to labeling products based on a hierarchical taxonomy in an online concierge system. More particularly, the disclosure relates to inferring a category of a hierarchical taxonomy for an unlabeled product using a replacement model that determines replacements for the unlabeled product.

An online concierge system may use a hierarchical taxonomy of products to understand information about products being sold at retailers. For instance, the online concierge system may use the hierarchical taxonomy to find replacements for products, perform search queries related to products, and facilitate orders of products. However, adding each of these products manually to a hierarchical taxonomy manual may be inefficient since hundreds of thousands of products may be available for purchase via the online concierge system. Thus, a system for labeling products based on a hierarchical taxonomy is necessary.

### SUMMARY

An online concierge system populates a hierarchical taxonomy of products using a replacement model. The online concierge system inputs a product that is not labeled based on (i.e., not included in) the hierarchical taxonomy to the replacement model. The replacement model determines likelihoods that one or more products labeled based on the hierarchical taxonomy could serve as replacements for the product. The online concierge system selects a product of the one or more products labeled based on the hierarchical taxonomy with the highest likelihood and labels the product using a category of the selected product.

In particular, the online concierge system accesses a hierarchical taxonomy of products each labeled with a category of the hierarchical taxonomy. The online concierge system receives, from an inventory database, an unlabeled product. The unlabeled product is not included in the hierarchical taxonomy. The online concierge system inputs the unlabeled product to a replacement model. The replacement model is trained to output, for each of one or more labeled products from the hierarchical taxonomy, a likelihood that a user would select the labeled product as a replacement for an input product. The online concierge system selects a labeled product from the one or more labeled products based on the likelihoods. The online concierge system adds the unlabeled product to a category of the hierarchical taxonomy based on the selected labeled product.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

FIG. 1 illustrates the environment of an online concierge system, according to one embodiment.

FIG. 2 is a block diagram of an online concierge system, according to one embodiment.

FIG. 3A is a block diagram of the customer mobile application (CMA), according to one embodiment.

FIG. 3B is a block diagram of the picker mobile application (PMA), according to one embodiment.

FIG. 4 is a block diagram of a product engine, according to one embodiment.

FIGS. 5A-5C illustrate labeling products based on a portion of a hierarchical taxonomy, according to one embodiment.

FIG. 6 illustrates a flowchart of a process for adding a product to a category of a hierarchical taxonomy, according to one embodiment.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

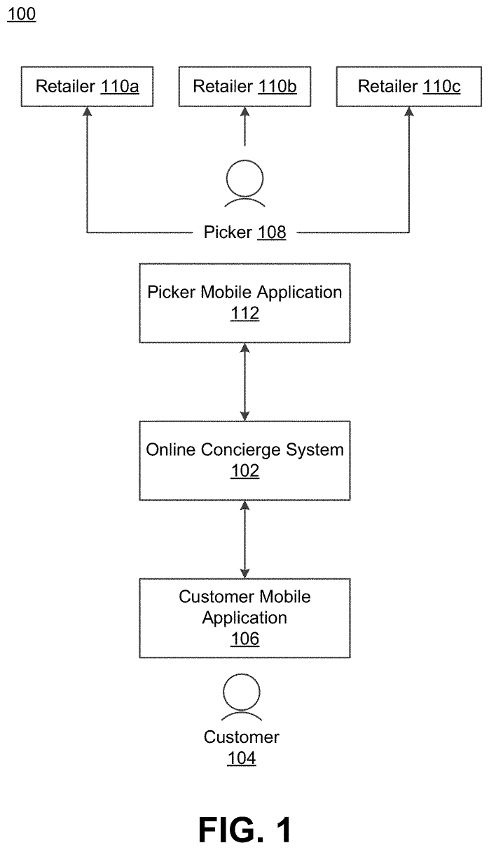

FIG. 1 illustrates the environment 100 of an online concierge system 102, according to one embodiment. The figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral. For example, “110” in the text refers to reference numerals “110a” and/or “110b” in the figures. Further, reference to using an online concierge system 102 for this invention is made throughout this specification. However, in other embodiments, another online system or mobile application may be used to determine recommended items for a shopping list.

The environment 100 includes an online concierge system 102. The online concierge system 102 is configured to receive orders from one or more customers 104 (only one is shown for the sake of simplicity). An order specifies a list of goods (items or products) to be delivered to the customer 104. The order also specifies the location to which the goods are to be delivered, and a time window during which the goods should be delivered. In some embodiments, the order specifies one or more retailers from which the selected items should be purchased. The customer may use a customer mobile application (CMA) 106 to place the order; the CMA 106 is configured to communicate with the online concierge system 102.

The online concierge system 102 is configured to transmit orders received from customers 104 to one or more pickers 108. A picker 108 may be a contractor, employee, or other person (or entity) who is enabled to fulfill orders received by the online concierge system 102. The environment 100 also includes three retailers 110a, 110b, and 110c (only three are shown for the sake of simplicity; the environment could include hundreds of retailers). The retailers 110 may be physical retailers, such as grocery stores, discount stores, department stores, etc., or non- public warehouses storing items that can be collected and delivered to customers. Each picker 108 fulfills an order received from the online concierge system 102 at one or more retailers 110, delivers the order to the customer 104, or performs both fulfillment and delivery. In one embodiment, pickers 108 make use of a picker mobile application 112 which is configured to interact with the online concierge system 102.

### ONLINE CONCIERGE SYSTEM

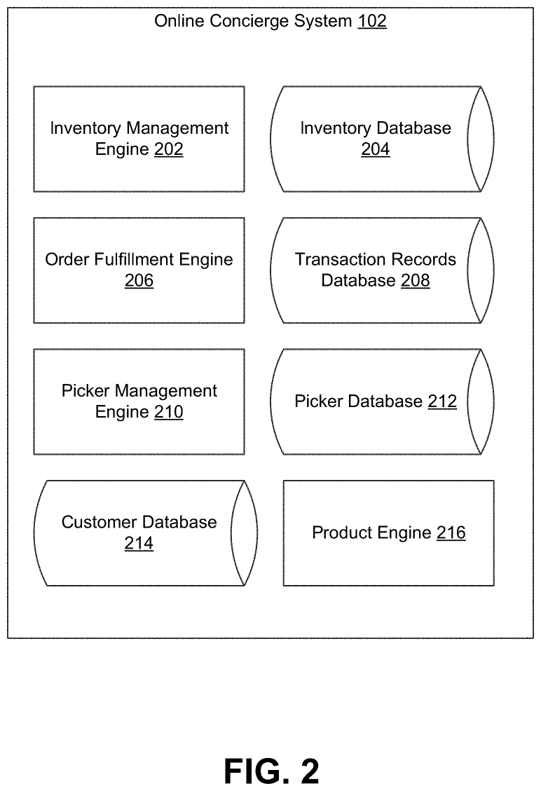

FIG. 2 is a block diagram of an online concierge system 102, according to one embodiment. The online concierge system 102 includes an inventory management engine 202, which interacts with inventory systems associated with each retailer 110. In one embodiment, the inventory management engine 202 requests and receives inventory information maintained by the retailer 110. The inventory information may include quantity of an item in stock, images of the item, price of the item, and date of restock of the item. The inventory of each retailer 110 is unique and may change over time. The inventory management engine 202 monitors changes in inventory for each participating retailer 110. The inventory management engine 202 is also configured to store inventory records in an inventory database 204. The inventory database 204 may store information in separate records—one for each participating retailer 110—or may consolidate or combine inventory information into a unified record. Inventory information includes both qualitative and qualitative information about items, including size, color, weight, SKU, serial number, and so on. In one embodiment, the inventory database 204 also stores purchasing rules associated with each item, if they exist. For example, age-restricted items such as alcohol and tobacco are flagged accordingly in the inventory database 204.

The online concierge system 102 also includes an order fulfillment engine 206 which is configured to synthesize and display an ordering interface to each customer 104 (for example, via the customer mobile application 106). The order fulfillment engine 206 is also configured to access the inventory database 204 in order to determine which products are available at which retailers 110. The order fulfillment engine 206 determines a sale price for each item ordered by a customer 104. Prices set by the order fulfillment engine 206 may or may not be identical to in-store prices determined by retailers (which is the price that customers 104 and pickers 108 would pay at retailers). The order fulfillment engine 206 also facilitates transactions associated with each order. In one embodiment, the order fulfillment engine 206 charges a payment instrument associated with a customer 104 when he/she places an order. The order fulfillment engine 206 may transmit payment information to an external payment gateway or payment processor. The order fulfillment engine 206 stores payment and transactional information associated with each order in a transaction records database 208.

In some embodiments, the order fulfillment engine 206 also shares order details with retailer 110. For example, after successful fulfillment of an order, the order fulfillment engine 206 may transmit a summary of the order to the appropriate retailer 110. The summary may indicate the items purchased, the total value of the items, and in some cases, an identity of the picker 108 and customer 104 associated with the transaction. In one embodiment, the order fulfillment engine 206 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 206, which provides detail of all orders which have been processed since the last request.

The order fulfillment engine 206 may interact with a picker management engine 210, which manages communication with and utilization of pickers 108. In one embodiment, the picker management engine 210 receives a new order from the order fulfillment engine 206. The picker management engine 210 identifies the appropriate retailer 110 to fulfill the order based on one or more parameters, such as the contents of the order, the inventory of the retailers, and the proximity to the delivery location. The picker management engine 210 then identifies one or more appropriate pickers 108 to fulfill the order based on one or more parameters, such as the pickers' proximity to the appropriate retailer 110 (and/or to the customer 104), his/her familiarity level with that particular retailer 110, and so on. Additionally, the picker management engine 210 accesses a picker database 212 which stores information describing each picker 108, such as his/her name, gender, rating, previous shopping history, and so on. The picker management engine 210 transmits the list of items in the order to the picker 108 via the picker mobile application 112. The picker database 212 may also store data describing the sequence in which the pickers' picked the items in their assigned orders.

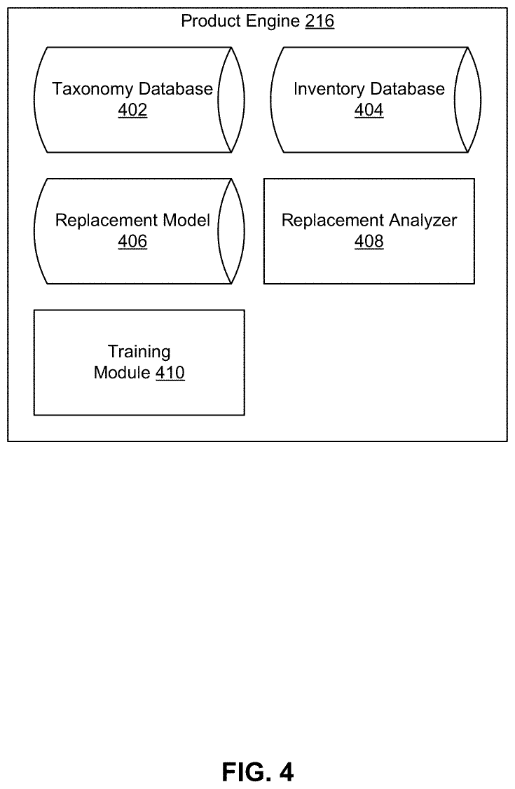

As part of fulfilling an order, the order fulfillment engine 206 and/or picker management engine 210 may access a customer database 214 which stores information describing each customer. This information could include each customer's name, address, gender, shopping preferences, favorite items, stored payment instruments, and so on. The online concierge system 102 also includes a product engine 216, which is further described in relation to FIG. 4.

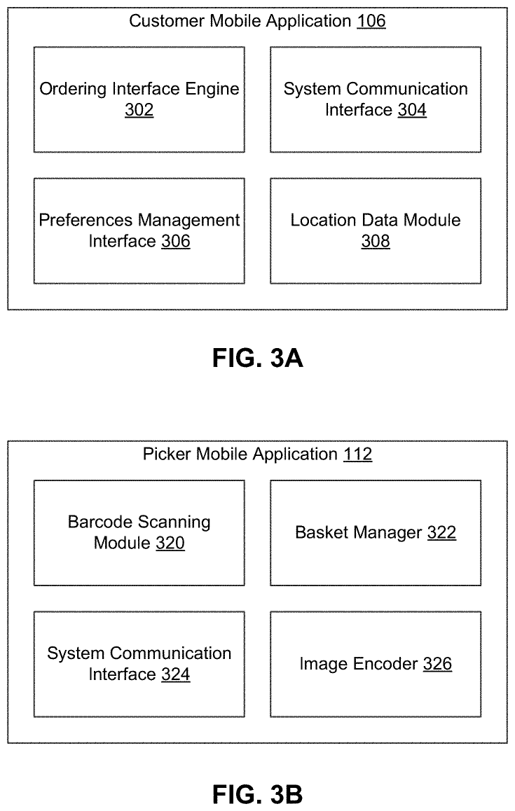

FIG. 3A is a block diagram of the customer mobile application (CMA) 106, according to one embodiment. The customer 104 accesses the CMA 106 via a client device, such as a mobile phone, tablet, laptop, or desktop computer. The CMA 106 may be accessed through an app running on the client device or through a website accessed in a browser. The CMA 106 includes an ordering interface engine 302, which provides an interactive interface, known as a customer ordering interface, with which the customer 104 can browse through and select products and place an order.

Customers 104 may also use the customer ordering interface to message with pickers 108 and receive notifications regarding the status of their orders. Customers 104 may view their orders and communicate with pickers regarding an issue with an item in an order using the customer ordering interface. Customers 104 may also view and select recommended items to add to their online shopping cart via the customer ordering interface. Recommended items are items that would complement the items in a customer's online shopping cart, and the online concierge system determines recommended items by analyzing recipes with a subset of the items in the online shopping cart. For example, the order fulfillment engine 206 may determine, based on a list of items in a customer's online shopping cart, that “tomato” would complement the items given that the online shopping cart includes “basil” and “pasta.” The process of determining recommended items is further described in relation to FIG. 4.

The CMA 106 also includes a system communication interface 304 which, among other functions, receives inventory information from the online concierge system 102 and transmits order information to the online concierge system 102. The CMA 106 also includes a preferences management interface 306 which allows the customer 104 to manage basic information associated with his/her account, such as his/her home address and payment instruments. The preferences management interface 306 may also allow the user to manage other details such as his/her favorite or preferred retailers 110, preferred delivery times, special instructions for delivery, and so on.

FIG. 3B is a block diagram of the picker mobile application (PMA) 112, according to one embodiment. The picker 108 accesses the PMA 112 via a mobile client device, such as a mobile phone or tablet. The PMA 112 may be accessed through an app running on the mobile client device or through a website accessed in a browser. The PMA 112 includes a barcode scanning module 320 which allows a picker 108 to scan an item at a retailer 110 (such as a can of soup on the shelf at a grocery store). The barcode scanning module 320 may also include an interface which allows the picker 108 to manually enter information describing an item (such as its serial number, SKU, quantity and/or weight) if a barcode is not available to be scanned. The PMA 112 also includes a basket manager 322 which maintains a running record of items collected by the picker 108 for purchase at a retailer 110. This running record of items is commonly known as a “basket”. In one embodiment, the barcode scanning module 320 transmits information describing each item (such as its cost, quantity, weight, etc.) to the basket manager 322, which updates its basket accordingly. The PMA 112 also includes an image encoder 326 which encodes the contents of a basket into an image. For example, the image encoder 326 may encode a basket of goods (with an identification of each item) into a QR code which can then be scanned by an employee of the retailer 110 at check-out.

The PMA 112 also includes a system communication interface 324, which interacts with the online concierge system 102. For example, the system communication interface 324 receives information from the online concierge system 102 about the items of an order, such as when a customer updates an order to include more or less items. The system communication interface may receive notifications and messages from the online concierge system 102 indicating information about an order or communications from a customer 104. The system communication interface 324 may additionally generate a picker order interface. The picker order interface is an interactive interface through which pickers may message with customers 104 and receive notifications regarding the status of orders they are assigned.

FIG. 4 is a block diagram of the product engine 216, according to one embodiment. The product engine 216 includes a taxonomy database 402, an inventory database 404, a replacement model 406, a replacement analyzer 408, and a training module 410. In some embodiments, the product engine 216 may include a different number or variety of modules than those shown in FIG. 4. For example, in some embodiments, the product engine 216 may include one or more alternative models that function to label a product with a category of the hierarchical taxonomy.

The replacement analyzer 408 determines replacements for products. Replacements are products that can be alternatively used instead of the product and have similar characteristics to the product. For example, the product “Winston's Whole Wheat Bread” can be replaced with “Bee Honey Wheat Bread” and “Grain Harvest Organic Wheat Bread,” which are similar wheat breads of different brands. In another example, a replacement for a “butter” product may be a “ghee” product or an “olive oil” product, which may be used to cook in, similar to the “butter” product. These characteristics of products may be stored in the inventory database 404, as described below.

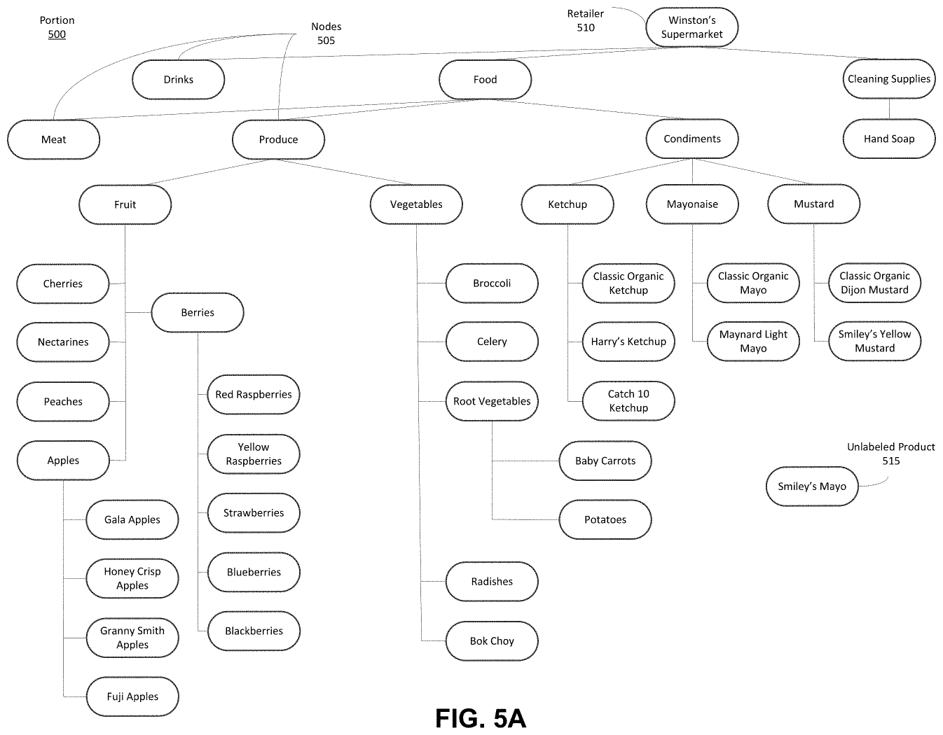

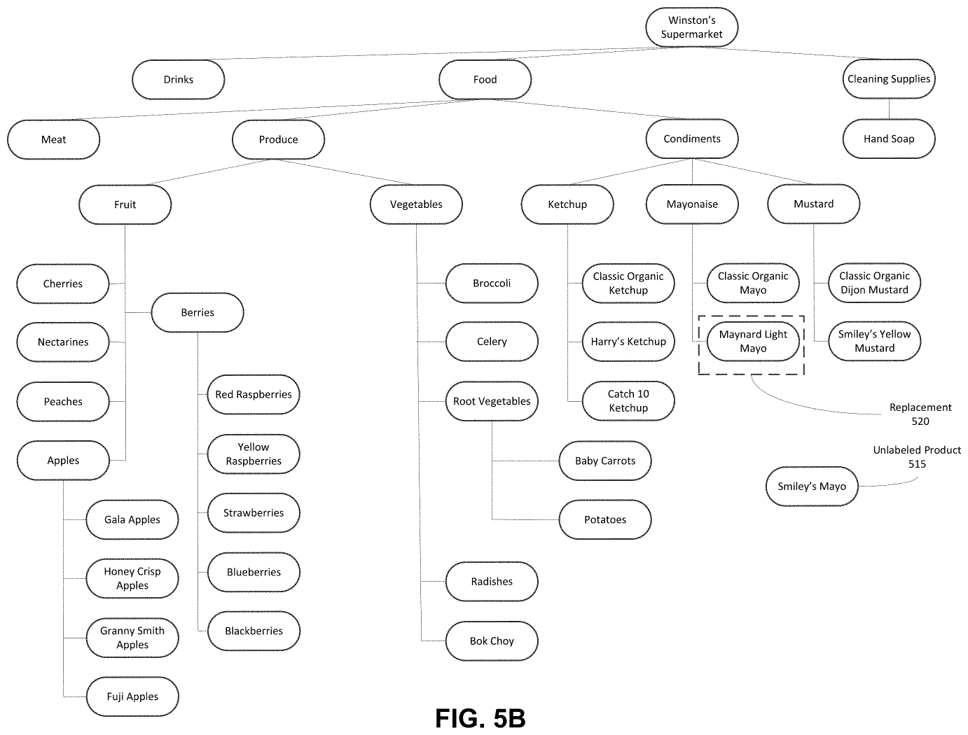

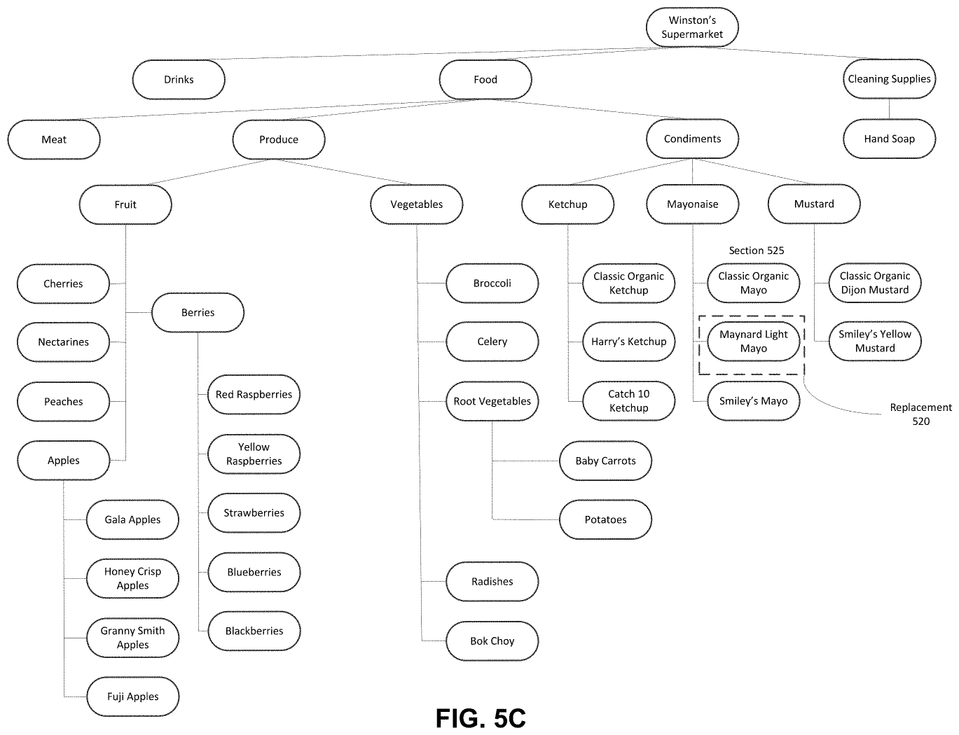

The replacement analyzer 408 accesses a taxonomy database 402, which stores a hierarchical taxonomy of products sold by retailers 110 associated with the online concierge system 102. The hierarchical taxonomy is a taxonomy of ranked categories of products sold at one or more retailers 110. Each category may include a plurality of other subcategories (also referred to as “categories” for simplicity) and a plurality of products labeled with the category. For example, the product “Butterfly Organic Butter” may be labeled with the categories “Dairy” and “Butter,” where “Butter” is a category of “Dairy.” The hierarchical taxonomy may be generated by a machine-learning model trained to determine a hierarchy of products based on retailer 110 information, an inventory of products, historical orders placed by customer 104, and/or historical search queries entered by customers 104 via the CMA 106. In some cases, portions of the hierarchical taxonomy may be manually labeled by a moderator. An example of a portion of the hierarchical taxonomy is shown in FIGS. 5A-5C.

The replacement analyzer 408 retrieves an unlabeled product from the inventory database 404. The inventory database 404 may be the same as the inventory database 204 shown in FIG. 2 and includes an inventory of products available at retailers 110 connected to the online concierge system 102. The unlabeled product is a product available at one or more retailers 110 that is not labeled with (i.e., not included in) a category of a hierarchical taxonomy. The replacement analyzer 408 may confirm that the unlabeled product is not labeled based on the hierarchical taxonomy by cross-referencing the product with the taxonomy database 402. To predict a replacement for the unlabeled product, the replacement analyzer 408 applies a replacement model 406. The online concierge system 102 may use the replacement model 406 to determine one or more replacements for a product when the product is unavailable for purchase via the online concierge system 102. The online concierge system 102 may also use the replacement model 408 to label a product based on the hierarchical taxonomy (e.g., labeling the product based on how replacements for the product are labeled). The replacement model 406 is configured to predict a likelihood that a product is a replacement for an input product. The replacement model 406 may be a machine learning model, such as a deep neural network, a regression model, a classifier, or any other suitable type of machine learning model. In some embodiments, the replacement model 406 is a query system that queries a graph database of historical data describing replacements for products. The historical data may describe search queries entered by customers 104 via the CMA 106 and products viewed and/or ordered as a result of each search query.

To predict the likelihoods, the replacement model 406 retrieves characteristics of the unlabeled product from the inventory database 404. Characteristics may include types of the product (e.g., different flavors, age, etc.), sizes of the product sold at retailers 110, attributes of the product (i.e., cheese crackers are “snack food” and “cheesy” or the unlabeled product is “kosher,” “vegan,” etc.), and the like. In some embodiments, the characteristics of the unlabeled product may include name, location at a retailer 110 (e.g., aisle number and/or department), brand, and price. The replacement analyzer 408 selects a set of labeled products as potential replacements for the unlabeled product. In some embodiments, the replacement analyzer 408 selects labeled products with a threshold number of the same characteristics as the unlabeled product. In some embodiments, the set of labeled products are all products the inventory database 404 or the taxonomy database 402. For each labeled product in the set, the replacement analyzer 408 inputs the labeled product and the unlabeled product, including characteristics of each, to the replacement model 406. Further, in some instances, the replacement analyzer may input features that relate to the user engagement with the products, such as a number of times (or percentage of time) that a labeled product has been used to replace the unlabeled product on the online concierge system 102. The replacement model 406 outputs a likelihood that the labeled product would be used to replace the unlabeled product. For example, the product “Moo Moo Organic 2% Milk” may have a 70% likelihood of being replaced by “Moo Moo 2% Milk” and a 15% likelihood of being replaced by “Moo Moo Organic Whole Milk.” The replacement model 406 is trained by the training module 410, which is further described below.

The replacement analyzer 408 receives a likelihood for each of the set of labeled products from the replacement model 406. The replacement analyzer 408 selects a replacement from the set with the highest likelihood of replacing the unlabeled product. For the selected replacement, the replacement analyzer 408 retrieves, from the taxonomy database 402, one or more categories that the replacement is labeled with based on the hierarchical taxonomy. The replacement analyzer 408 labels the unlabeled product with the one or more categories by adding the newly labeled product to hierarchical taxonomy as stored in the taxonomy database 402.

In an alternate embodiment, the replacement analyzer 408 determines a set of labeled products with a likelihood above a threshold value. For instance, the replacement analyzer 408 may add labeled products with a likelihood of over 85% to the set. The replacement analyzer retrieves, for each labeled product in the set, one or more categories the labeled product is labeled with. The replacement analyzer 408 determines one or more categories for the unlabeled product based on commonality among the retrieved categories and labels the unlabeled product with the one or more categories. For example, if 10 of 11 of the labeled products are labeled with the category “Tea,” then the replacement analyzer 408 may label the unlabeled product with the category “Tea.” Furthermore, if the replacement analyzer 408 determines that multiple subcategories have commonality, the replacement analyzer may select a subcategory with the highest commonality and only label the unlabeled product with categories related to the selected subcategory.

The replacement model 406 may be trained by a training module 410 using training data describing replacements made by customers 104. For instance, a customer 104 may have an opportunity to replace a first product with a second product when the first product is unavailable. This may occur in a plurality of scenarios as the customer 104 engages with the CMA 106, such as when the customer 104 enters a search query for the first product, receives a suggestion of the second product when viewing information about the first product, and the like. Whether or not the customer 104 replaces the first product with the second product may be stored as historical data by the CMA 106, which the training module 410 may use as training data to train the replacement model 406. For example, if a customer 104 entered the search query “organic milk” and ended up ordering “Smooth Sailing Vanilla Almond Milk” shortly after viewing “Sweet Farms Vanilla Almond Milk,” the training data would include the set of “Smooth Sailing Vanilla Almond Milk” and “Sweet Farms Vanilla Almond Milk” labeled with a “1.” Further, if the customer 104 also viewed “Store Brand Almond Milk” after viewing “Sweet Farms Vanilla Almond Milk,” but did not order “Store Brand Almond Milk,” the training data would include the set of “Store Brand Almond Milk” and “Sweet Farms Vanilla Almond Milk” labeled with a “0.” Each set may also include the characteristics of each product. The training data comprises a plurality of labeled sets of products viewed by a plurality of customers in the scenarios. The training module 410 trains the replacement model 406 on the labeled sets of products to predict a computed likelihood that a second product is a replacement for a second product.

In some embodiments, the training data may also include historical data representing feedback from customers 104 about products used as replacements. For instance, a customer 104 may provide feedback on a replacement made for a product in an order. In one example, a picker 108 may replace a product upon determining that the product is unavailable at a retailer 110 when shopping. The CMA 106 may send a notification of the replacement to the customer 104 to approve or deny. Further, upon receiving the order, the customer may enter feedback via the CMA 106 about the replacement for the product (e.g., whether the customer 104 liked the replacement or not or a rating of the replacement). In another instance, the customer 104 may select a replacement for a product before placing the order (e.g., upon checking out, the CMA 106 may indicate that a product is unavailable and needs to be replaced). These occurrences of products being replaced may be stored as historical data by the CMA 106.

The training module 410 may label the historical data to use as training data. This training data comprises a plurality of labeled sets of products viewed by a plurality of customers in the occurrences. For example, if a customer 104 replaced the product “Smooth Sailing Vanilla Almond Milk” with “Sweet Farms Vanilla Almond Milk,” the training data would include the set of “Smooth Sailing Vanilla Almond Milk” and “Sweet Farms Vanilla Almond Milk” labeled with a “1.” In another example, if the customer 104 rated the replacement “Store Brand Almond Milk” for “Sweet Farms Vanilla Almond Milk” as a 1 out of 5, the training data would include the set of “Store Brand Almond Milk” and “Sweet Farms Vanilla Almond Milk” labeled with a “0.” Each set may also include the characteristics of each product. Further, in some embodiments, the training data may include each sets of the unlabeled product with each product at a retailer 110 (or each product within a similar department or category of the unlabeled product) labeled with a similarity. The similarity may be a percentage determined based on how many attributes the unlabeled product and product share. For example, the set of products “Red Raspberries” and “Organic Yellow Raspberries” may be labeled with a similarity of 96% due to having many of the same attributes (e.g., both are “fruit,” both sold in a “fruit department,” etc.). The training module 410 trains the replacement model 406 on the labeled sets of products to predict a computed likelihood that a second product is a replacement for a second product.

FIGS. 5A-5C illustrate labeling products based on a portion 500 of a hierarchical taxonomy, according to one embodiment. FIGS. 5A-5C show a portion 500 of the hierarchical taxonomy rather than the entirety of the hierarchical taxonomy. The hierarchical taxonomy includes a plurality of nodes 505 that are hierarchically connected. The nodes 505 describe categories of products available at a retailer 510. For example, the retailer 510 may sell products that can be classified as “food,” which includes “produce” and “condiments,” among other categories of food. Furthermore, “produce” includes “fruit” and “vegetables,” and “fruit” includes “cherries,” which are sold at the retailer 510. In some instances, “cherries” may also be a category associated with more types or particular brands of cherries, like “yellow cherries” or “Sherry's Organic red cherries.” In some embodiments, the hierarchical taxonomy is not categorized by retailer 510, as shown in FIGS. 5A-5C.

For unlabeled products 515 being sold at the retailer 510, the product engine 216 determines a likely replacement for each unlabeled product 515. For instance, for the unlabeled product 515 “Smiley's Mayo,” the product engine 216 determines a product in the hierarchical taxonomy with the highest likelihood of being used to replace the unlabeled product 515. This product is known as a “replacement” 520 for the unlabeled product 515. As shown in FIG. 5B, the product engine 216 determines that the replacement 520 “Maynard Light Mayo” has the highest likelihood of being used to replace “Smiley's Mayo.” Thus, as shown in FIG. 5C, the product engine labels the unlabeled product 515 “Smiley's Mayo” with the same categories as the replacement 520 “Maynard Light Mayo” is labeled with. This may be represented by “adding” the unlabeled product 515 to the same section of the hierarchical taxonomy as the replacement 520.

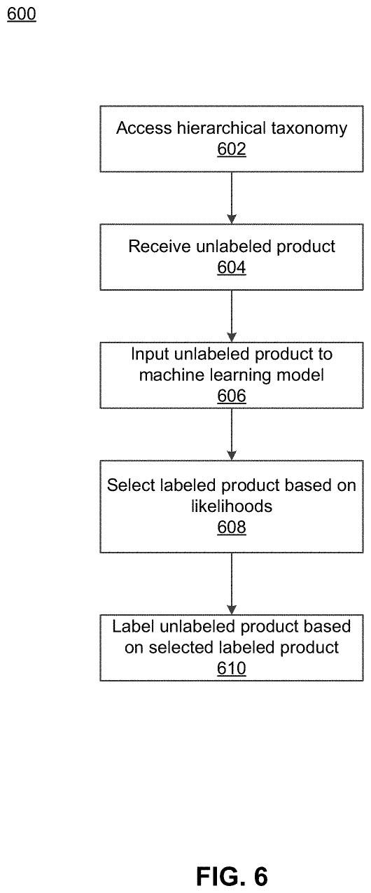

FIG. 6 illustrates a flowchart of a process 600 for labeling a product with a category of a hierarchical taxonomy, according to one embodiment. For instance, the replacement analyzer 408 accesses 602 a hierarchical taxonomy stored in the taxonomy database 402. In some embodiments, the hierarchical taxonomy may be the same for all retailers 110 or geographic locations or the taxonomy database 402 may store a plurality of hierarchical taxonomies that are each specific to a retailer 110 or geographic region. The replacement analyzer 408 receives 604 an unlabeled product from the inventory database 404 and determines a set of labeled products that may be potential replacements for the unlabeled product. The labeled products may be products from the hierarchical taxonomy with similar characteristics to the unlabeled product (e.g., include at least a threshold number of the same characteristics). Alternatively, the unlabeled product may be associated with a category from the taxonomy (e.g., “Fruit” or “Snacks”), and the replacement analyzer may select labeled products included in the category. The replacement analyzer 408 inputs the unlabeled product and each of the labeled products to the replacement model 406 to predict 606 a replacement for the unlabeled product. The replacement model 406 is trained to output, for each labeled product, a likelihood a customer 104 would select the labeled product as a replacement for the unlabeled product.

In another embodiment, the replacement analyzer 408 may add a product from each category in the hierarchical taxonomy to a set labeled products that may be replacements for the unlabeled product. The replacement analyzer 408 inputs each labeled product with the unlabeled product to the replacement model 406. The replacement analyzer 408 selects a labeled product with the highest likelihood as output from the replacement model 406 and adds each product in the category of the selected labeled product to the set of labeled products. The replacement analyzer 408 may iterate upon inputting the unlabeled product and each of the set of the labeled products to the replacement model 406, selecting a labeled product with a highest likelihood, and adding products in the same category as the selected labeled product until the selected labeled product has a likelihood over a threshold percentage or for a threshold number of iterations.

The replacement analyzer 408 selects 608 a labeled product from the set of labeled products as a replacement for the unlabeled product based on the likelihoods. For instance, the replacement analyzer may select the labeled product with the highest likelihood. The replacement analyzer 408 labels 610 the unlabeled product with the one or more categories of the hierarchical taxonomy based on the selected labeled product (i.e., “replacement”). For instance, if the replacement is labeled with the categories “Snacks” and “Crackers,” then the replacement analyzer 408 will label the unlabeled product with the categories “Snacks” and “Crackers.” The replacement analyzer 408 updates the hierarchical taxonomy to include the newly labeled product (e.g., previously the “unlabeled product”) labeled with the one or more categories in the taxonomy database 402.

In some embodiments, the process 600 shown in FIG. 6 may include alternative or additional steps. For instance, in some embodiments, the replacement model 406 may be a query system that queries a graph database of historical data describing replacements for products. In another example, the replacement analyzer 408 may transmit, for display at a moderator client device, the one or more categories of the labeled product with the highest likelihood. If the moderator approves the one or more categories, the replacement analyzer 408 then labels the unlabeled product with the one or more categories.

### OTHER CONSIDERATIONS

The present invention has been described in particular detail with respect to one possible embodiment. Those of skill in the art will appreciate that the invention may be practiced in other embodiments. First, the particular naming of the components and variables, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely for purposes of example, and is not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic- optical disks, read-only memories (ROMs), random access memories (RAMs), EPROMs, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer-implemented method comprising:
accessing a hierarchical taxonomy of products in an online concierge system, each product labeled with a category of the hierarchical taxonomy;
receiving, from an inventory database, an unlabeled product, the unlabeled product not included in the hierarchical taxonomy;
inputting the unlabeled product to a replacement model, wherein the replacement model is trained to output, for each of one or more labeled products from the hierarchical taxonomy, a likelihood that a user would select the labeled product as a replacement for an input product;
selecting a labeled product from the one or more labeled products based on the likelihoods; and
adding the unlabeled product to a category of the hierarchical taxonomy based on the selected labeled product.

2. The computer-implemented method of claim 1, wherein the selected labeled product has a highest likelihood of the likelihoods.

3. The computer-implemented method of claim 1, wherein the one or more labeled products are selected for input to the replacement model based on having one or more of the same characteristics as the unlabeled product.

4. The computer-implemented method of claim 1, wherein the replacement model is a machine learning model trained on historical data describing products selected by customers as replacements for an unavailable product.

5. The computer-implemented method of claim 1, wherein the replacement model is a query system that queries a graph database of replacements for products in the online concierge system.

6. The computer-implemented method of claim 1, wherein adding the unlabeled product to the category of the hierarchical taxonomy comprises:
sending, to a mobile device of a moderator, the category for display; and
responsive to receiving confirmation from the moderator via the mobile device, adding the unlabeled product to the category.

7. The computer-implemented method of claim 1, wherein a subset of the hierarchical taxonomy was manually labeled by a moderator.

8. A non-transitory computer-readable storage medium comprising instructions executable by a processor, the instructions comprising:
accessing a hierarchical taxonomy of products in an online concierge system, each product labeled with a category of the hierarchical taxonomy;
receiving, from an inventory database, an unlabeled product, the unlabeled product not included in the hierarchical taxonomy;
inputting the unlabeled product to a replacement model, wherein the replacement model is trained to output, for each of one or more labeled products from the hierarchical taxonomy, a likelihood that a user would select the labeled product as a replacement for an input product;
selecting a labeled product from the one or more labeled products based on the likelihoods; and
adding the unlabeled product to a category of the hierarchical taxonomy based on the selected labeled product.

9. The non-transitory computer-readable storage medium of claim 8, wherein the selected labeled product has a highest likelihood of the likelihoods.

10. The non-transitory computer-readable storage medium of claim 8, wherein the one or more labeled products are selected for input to the replacement model based on having one or more of the same characteristics as the unlabeled product.

11. The non-transitory computer-readable storage medium of claim 8, wherein the replacement model is a machine learning model trained on historical data describing products selected by customers as replacements for an unavailable product.

12. The non-transitory computer-readable storage medium of claim 8, wherein the replacement model is a query system that queries a graph database of replacements for products in the online concierge system.

13. The non-transitory computer-readable storage medium of claim 8, wherein the instructions for adding the unlabeled product to the category of the hierarchical taxonomy comprise:
sending, to a mobile device of a moderator, the category for display; and
responsive to receiving confirmation from the moderator via the mobile device, adding the unlabeled product to the category.

14. The non-transitory computer-readable storage medium of claim 8, wherein a subset of the hierarchical taxonomy was manually labeled by a moderator.

15. A computer system comprising:
a computer processor; and
a non-transitory computer-readable storage medium storage instructions that when executed by the computer processor perform actions comprising:
accessing a hierarchical taxonomy of products in an online concierge system, each product labeled with a category of the hierarchical taxonomy;
receiving, from an inventory database, an unlabeled product, the unlabeled product not included in the hierarchical taxonomy;
inputting the unlabeled product to a replacement model, wherein the replacement model is trained to output, for each of one or more labeled products from the hierarchical taxonomy, a likelihood that a user would select the labeled product as a replacement for an input product;
selecting a labeled product from the one or more labeled products based on the likelihoods; and
adding the unlabeled product to a category of the hierarchical taxonomy based on the selected labeled product.

16. The computer system of claim 15, wherein the selected labeled product has a highest likelihood of the likelihoods.

17. The computer system of claim 15, wherein the one or more labeled products are selected for input to the replacement model based on having one or more of the same characteristics as the unlabeled product.

18. The computer system of claim 15, wherein the replacement model is a machine learning model trained on historical data describing products selected by customers as replacements for an unavailable product.

19. The computer system of claim 15, wherein the replacement model is a query system that queries a graph database of replacements for products in the online concierge system.

20. The computer system of claim 15, wherein adding the unlabeled product to the category of the hierarchical taxonomy comprises:
sending, to a mobile device of a moderator, the category for display; and
responsive to receiving confirmation from the moderator via the mobile device, adding the unlabeled product to the category.
